(19) United States
(12) Patent Application Publication
(10) Pub. No.: US 2008/0243684 A1
(43) Pub. Date: Oct. 2, 2008

(54) Method and apparatus for funding a transaction

(76) Inventors: Steven Ng, Irvine, CA (US); Tony O. Thompson, Fairfax, VA (US); Joshua Y. Kunin, Pasedena, CA (US)

Correspondence Address: Tony Otha Thompson, 4646 Hummingbird Lane, Fairfax, VA, 22033, US

(21) Appl. No.: 12/077,166

(22) Filed: Mar. 17, 2008

Related U.S. Application Data
(60) Provisional application No. 60/918,682, filed on Mar. 19, 2007.

(51) Int. Cl. G06Q 40/00

(52) U.S. Cl. 705/39

(57) ABSTRACT

The present invention provides a method and system for pooling commitments. The commitments may be made by different persons from different locations at different times. The commitments are pooled and used to fund a transaction.

### CLAIM OF PRIORITY

This patent application claims the benefit of the filing date of U.S. Provisional Application Ser. No. 60/918,682 filed on Mar. 19, 2007.

### FIELD OF THE INVENTION

This invention relates generally to a system and apparatus for funding a transaction, and specifically to a system and apparatus for funding a transaction by a plurality of purchasers.

### DESCRIPTION OF THE RELATED ART

Benefactors often look to give a product or service as a gift for a third party. These individuals often find the gift that they are looking for on traditional ecommerce sites such as amazon.com or borders.com. Oftentimes, however, a benefactor does not have sufficient funds to purchase the desired gift.

If a benefactor does not have sufficient funds, he can purchase a less expensive gift on the traditional ecommerce sites, but this option disappoints the purchaser, and may disappoint the recipient who may have been expecting the more expensive gift.

The benefactor can also pool funds (which may or may not include the benefactor's own funds) with other purchasers to deliver the desired gift. The benefactor can pool in two ways.

In the first type of pooling the benefactor collects funds from purchasers into his own account (which account may be in a bank, in the benefactor's pocket or elsewhere), and then uses that account in one way or another to purchase the desired gift. The traditional ecommerce sites provide no tools to facilitate this type of pooling.

In the second type of pooling the benefactor collects commitments from purchasers, usually in the form of a credit card or debit card, and then uses those commitments to purchase the desired gift. Although traditional ecommerce sites provide tools to support this type of pooling, those tools have several limitations. First, as shown in FIG. 1, all commitments must be made at the same time because all commitments must be made submitted simultaneously. Second, as shown in FIG. 2, all commitments must be made at the same place because all commitments must be submitted from the same computer.

### BRIEF DESCRIPTION OF THE DRAWINGS

These and other features, aspects and advantages of the present invention will become better understood by referring to the following description, the appended claims, and accompanying drawings, where:

FIG. 1 depicts traditional pooling where commitments are collected at the same time.

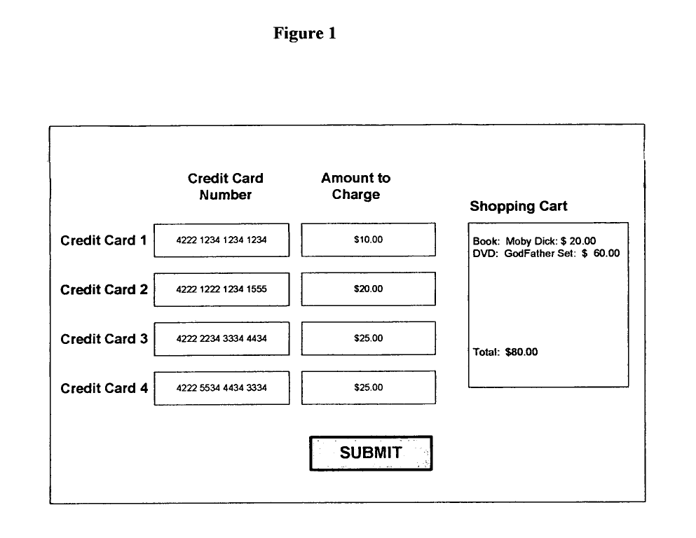

FIG. 2 depicts traditional pooling where commitments are collected at the same time.

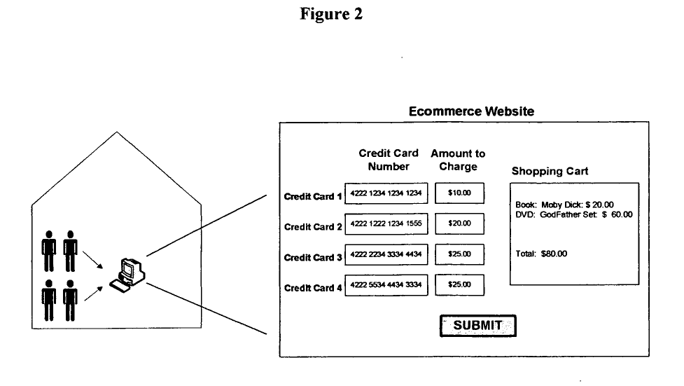

FIG. 3 depicts a client connecting to a server across a network such as the internet.

FIG. 4 depicts several clients connecting to a server from different locations and at different times.

FIG. 5 depicts a pooling and transaction manager.

FIG. 6 depicts a pooling and transaction manager.

FIG. 7a depicts an execution component of a pooling and transaction manager.

FIG. 7b depicts an execution component of a pooling and transaction manager.

FIG. 8 is an example of an architecture diagram of a client, a server including a web server and a server side processor and a pooling and transaction manager.

### SUMMARY OF THE INVENTION

The object of this invention is to provide a method and system for pooling commitments without time and space limitations.

### DETAILED DESCRIPTION OF THE INVENTION

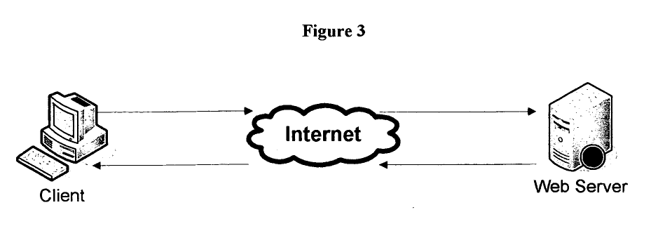

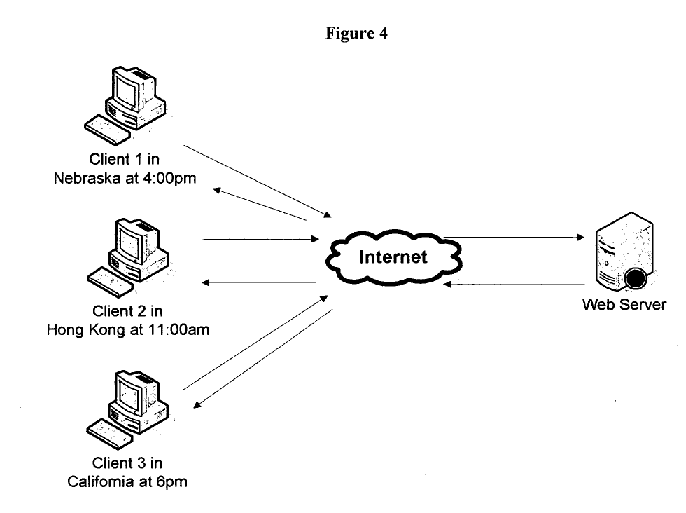

Using a client, a purchaser connects to a server across a network such as the internet as depicted in the physical architecture diagram of FIG. 3. The server may have components such as: (i) a web server to receive commitments and (ii) a server side processor to generate status and other information for transmission to a purchaser. It will also be appreciated by those skilled in the art that distinct physical architectures may be used. For example, the web server and the server side processor may be housed on the same machine, different machines, or partially on the same machine and partially on different machines. It will be appreciated by those skilled in the art that a plurality purchasers may connect to the server from different locations and at different times as depicted in FIG. 4.

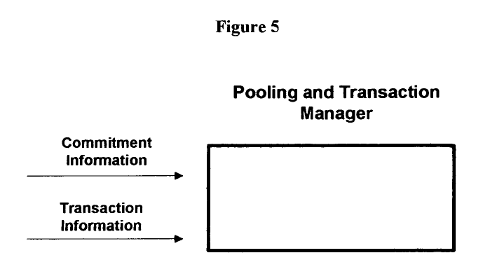

FIG. 5 depicts a pooling and transaction manager. The commitments are received from a web server and stored in memory by the pooling and transaction manager. It will be appreciated by those skilled in the art that a purchaser or benefactor may make multiple commitments in equal or unequal amounts. It will also be appreciated by those skilled in the art that different purchasers or benefactors may make commitments in equal or unequal amounts. The pooling and transaction manager also receives transaction information, which may include data such as gift identity and price, minimum commitment amount, and settings such as whether the commitments may be revocable or irrevocable. It will be appreciated by those skilled in the art that a gift may take many forms, such as tangible or intangible.

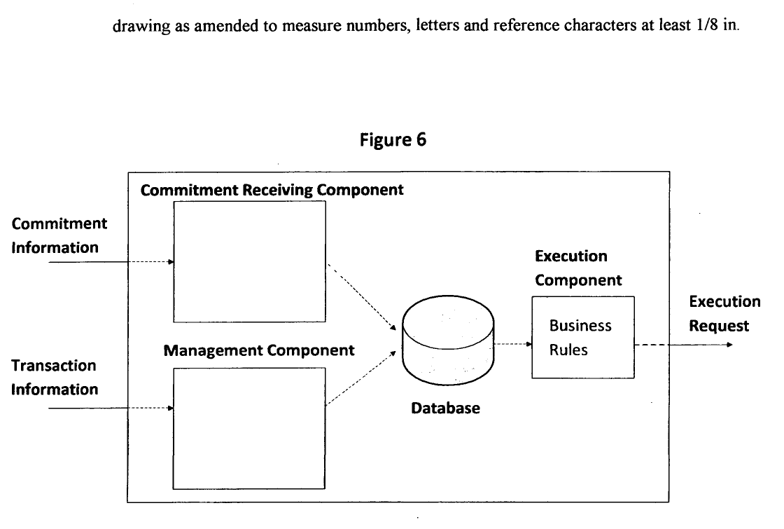

FIG. 6 depicts components which may be included in the pooling and transaction manager. A commitment receiving component receives commitments. A management component receives transaction information. A database stores (i) the commitments and associated information such as credit card number, commitment amount and other relevant information and (ii) the transaction information. An execution component which, based on settings, individual commitments, aggregate commitments, and other information, issues an execution request to a credit card component.

It will be appreciated by those skilled in the art that the pooling and transaction manager may include additional components.

For example, an additional component in the pooling and transaction manager might be a gift selection receiving component. Such a component would receive gift selection information, and would be used for a gift recipient to select a gift when the transaction information includes more than one gift to which benefactors may make funding commitments. It will be appreciated by those skilled in the art that said gift selection information may also be received by the same management component used to receive transaction information, by the execution component, or by another component. It will be further appreciated by those skilled in the art that said gift selection information may or may not be stored in the database.

As another example, an additional component in the pooling and transaction might be a termination request receiving component. Such a component would receive termination request information, and would be used to force the execution component to issue an execution request at a time different than it otherwise would have. It will be appreciated by those skilled in the art that said termination request information may also be received by the same management component used to receive transaction information, by the execution component, or by another component. It will be further appreciated by those skilled in the art that said termination request information may or may not be stored in the database.

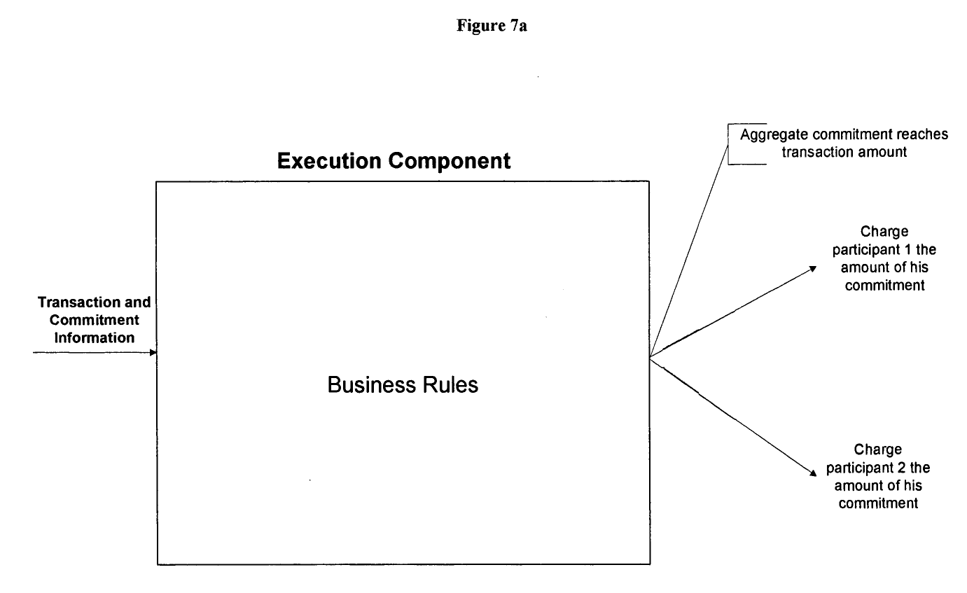

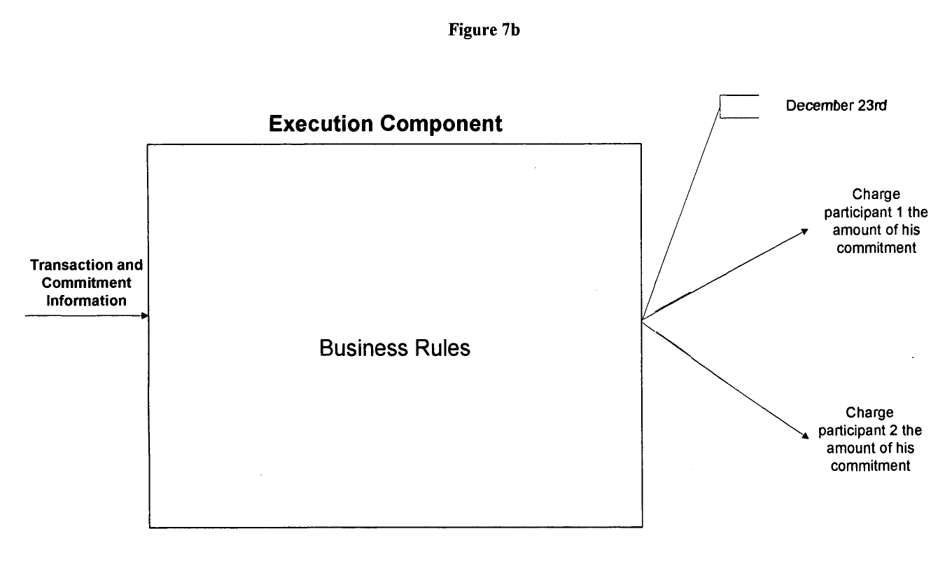

FIG. 7 depicts some factors which may determine when an execution request is issued as well as the contents of exemplary execution requests. Based on settings and rules, the execution component can issue an execution request on the happening of a variety of events, including but not limited to: (i) whenever a commitment is made, (ii) whenever the aggregate of commitments reaches a certain amount, (iii) at a certain time, (iv) or the happening of any combination of these or other events. Based on settings and rules, an execution request may include one request or a variety of requests, such requests including but not limited to: (i) a request to charge the credit cards of all purchasers in the full amount of the commitment made by each such purchaser; (ii) a request to charge the credit cards of only some of the purchasers; or (iii) a request to charge the credit cards of some or all purchasers in an amount less than the commitment made by each such purchaser.

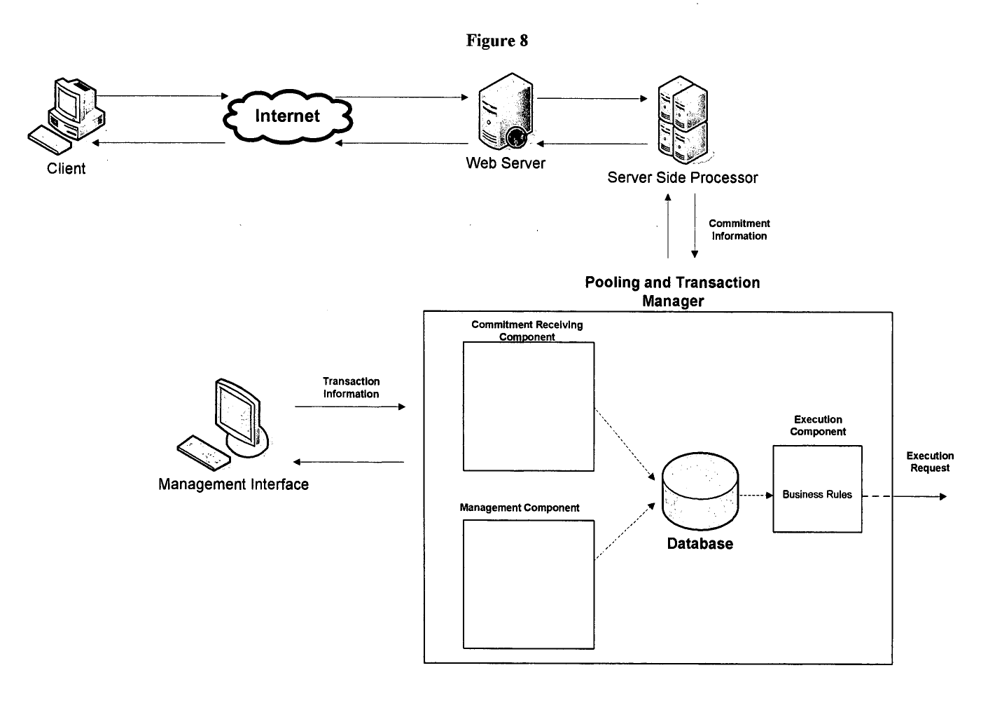

FIG. 8 is an example of an architecture diagram of a client, a server including a web server and a server side processor and a pooling and transaction manager.

1. A method for funding a transaction, comprising:
receiving transaction information;
receiving a plurality of funding commitments, at least two of which said commitments received from different locations or at different times, or both; and
based on said funding commitments and said transaction information, issuing an execution request.

2. The method of claim 1 wherein said transaction information includes at least one gift.

3. The method of claim 2 wherein said funding commitments include at least one gift designation.

4. The method of claim 2 wherein said funding commitments include no gift designation.

5. The method of claim 2 wherein some of said funding commitments include at least one gift designation and some of said funding commitments include no gift designation.

6. A method for funding a transaction, comprising:
receiving transaction information, said transaction information including at least one gift;
receiving a plurality of funding commitments, at least two of which said commitments received from different locations or at different times, or both;
receiving gift selection information based on said funding commitments, said transaction information and said selection information, issuing an execution request.

7. The method of claim 6 wherein said funding commitments include at least one gift designation.

8. The method of claim 6 wherein said funding commitments include no gift designation.

9. The method of claim 6 wherein some of said funding commitments include at least one gift designation and some of said funding commitments include no gift designation.

10. The method of claim 7 or claim 8 or claim 9 wherein said selection information includes at least one gift selection.

11. The method of any of claims 1 through 10 wherein said transaction information includes at least one gift price.

12. The method of any of claims 1 through 10 wherein the amount of each of said funding commitments is determined by the person making such funding commitment.

13. The method of any of claims 1 through 10 wherein the amount of some of said funding commitments is determined by the person making such funding commitment.

14. The method of any of claims 1 through 13 wherein the issuance of said execution request is based at least in part on the aggregate amount of funding commitments received.

15. The method of any of claims 1 through 13 wherein the issuance of said execution request is based at least in part on the aggregate amount of funding commitments received.

16. The method of any of claims 1 through 13 wherein the issuance of said execution request is based at least in part on the aggregate amount of funding commitments received.

17. The method of any of claims 1 through 16 wherein said financial commitment is an authorization against a financial account such as a credit card account or paypal account.

18. The method of any of claims 1 through 16 comprising the further step of funding said transaction by drawing on said financial commitments.

19. A method for funding a transaction, comprising:
periodically polling a database of transaction information and funding commitments; and
based on the results of said poll, using an execution request.

20. A method for funding a transaction, comprising:
periodically polling a database of transaction information, funding commitments and gift selection information; and
based on the results of said poll, using an execution request.

21. A method for funding a transaction, comprising:
periodically polling a database of transaction information and funding commitments;
receiving gift selection information; and
based on the results of said poll and on said gift selection information, using an execution request.

22. The method of claim 19 or claim 20 or claim 21 wherein said transaction information includes at least one gift.

23. The method of claim 22 wherein said funding commitments include at least one gift designation.

24. The method of claim 22 wherein said funding commitments include no gift designation.

25. The method of claim 22 wherein some of said funding commitments include at least one gift designation and some of said funding commitments include no gift designation.

26. The method of claim 21 wherein said funding commitments include at least one gift designation.

27. The method of claim 21 wherein said funding commitments include no gift designation.

28. The method of claim 21 wherein some of said funding commitments include at least one gift designation and some of said funding commitments include no gift designation.

29. The method of claim 27 or claim 28 or claim 29 wherein said selection information includes at least one gift selection.

30. The method of any of claims 19 through 29 wherein said transaction information includes at least one gift price.

31. The method of any of claims 19 through 29 wherein the amount of each of said funding commitments is determined by the person making such funding commitment.

32. The method of any of claims 19 through 29 wherein the amount of some of said funding commitments is determined by the person making such funding commitment.

33. The method of any of claims 1 through 32 wherein the issuance of said execution request is based at least in part on the aggregate amount of funding commitments received.

34. The method of any of claims 1 through 32 wherein the issuance of said execution request is based at least in part on the aggregate amount of funding commitments received.

35. The method of any of claims 1 through 32 wherein the issuance of said execution request is based at least in part on the aggregate amount of funding commitments received.

36. The method of any of claims 1 through 35 wherein said financial commitment is an authorization against a financial account such as a credit card account or paypal account.

37. The method of any of claims 1 through 35 comprising the further step of funding said transaction by drawing on said financial commitments.

38. A method for funding a transaction, comprising:
receiving transaction information;
receiving a plurality of funding commitments, at least two of which said commitments received from different locations or at different times, or both;
receiving a termination request; and
based on said funding commitments, said transaction information and said termination request, issuing an execution request.

39. The method of claim 38 wherein said transaction information includes at least one gift.

40. The method of claim 39 wherein said funding commitments include at least one gift designation.

41. The method of claim 39 wherein said funding commitments include no gift designation.

42. The method of claim 39 wherein some of said funding commitments include at least one gift designation and some of said funding commitments include no gift designation.

43. A method for funding a transaction, comprising:
receiving transaction information, said transaction information including at least one gift;
receiving a plurality of funding commitments, at least two of which said commitments received from different locations or at different times, or both;
receiving gift selection information
receiving termination request information
based on said funding commitments, said transaction information, said selection information and said termination request information, issuing an execution request.

44. The method of claim 43 wherein said funding commitments include at least one gift designation.

45. The method of claim 43 wherein said funding commitments include no gift designation.

46. The method of claim 43 wherein some of said funding commitments include at least one gift designation and some of said funding commitments include no gift designation.

47. The method of claim 44 or claim 45 or claim 46 wherein said selection information includes at least one gift selection.

48. The method of any of claims 38 through 47 wherein said transaction information includes at least one gift price.

49. The method of any of claims 38 through 47 wherein the amount of each of said funding commitments is determined by the person making such funding commitment.

50. The method of any of claims 38 through 47 wherein the amount of some of said funding commitments is determined by the person making such funding commitment.

51. The method of any of claims 38 through 50 wherein the issuance of said execution request is based at least in part on the aggregate amount of funding commitments received.

52. The method of any of claims 38 through 50 wherein the issuance of said execution request is based at least in part on the aggregate amount of funding commitments received.

53. The method of any of claims 38 through 50 wherein the issuance of said execution request is based at least in part on the aggregate amount of funding commitments received.

54. The method of any of claims 38 through 53 wherein said financial commitment is an authorization against a financial account such as a credit card account or paypal account.

55. The method of any of claims 38 through 53 comprising the further step of funding said transaction by drawing on said financial commitments.
